(19) United States
(12) Patent Application Publication
(10) Pub. No.: US 2025/0227363 A1
(43) Pub. Date: Jul. 10, 2025

(54) CONTROL APPARATUS, IMAGE PICKUP APPARATUS, AND CONTROL METHOD

(71) Applicant: CANON KABUSHIKI KAISHA, Tokyo (JP)

(72) Inventor: SHIMPEI ITAGAKI, Tokyo (JP)

(21) Appl. No.: 18/950,822

(22) Filed: Nov. 18, 2024

(30) Foreign Application Priority Data
Jan. 10, 2024 (JP) 2024-001629

(51) Int. Cl. H04N 23/60; H04N 23/63; H04N 23/667; H04N 23/951

(52) U.S. Cl. CPC H04N 23/64; H04N 23/63; H04N 23/667; H04N 23/951

(57) ABSTRACT

A control apparatus includes a processor configured to perform first processing for continuously shooting a plurality of images with a single imaging instruction, aligning the plurality of images, and combining the plurality of images into a single image. An output of an output unit during imaging executing the first processing in a first mode for automatically determining whether or not to execute the first processing is different from that during imaging executing the first processing in a second mode.

### BACKGROUND

### Technical Field

The present disclosure relates to a control apparatus, an image pickup apparatus, a control method, and a storage medium.

### Description of Related Art

Japanese Patent Laid-Open No. 2004-219765 discloses an image pickup apparatus, such as a camera using an image sensor, configured to perform processing (image stabilization using image combination) for aligning a plurality of images captured in a short time and then combining them to acquire an image equivalent to long exposure without camera shake.

The screen display for an image generated by image stabilization using image combination is different from that for an image generated by long-exposure imaging with the equivalent exposure time. That is, in long-exposure imaging, nothing is displayed on the screen during the exposure period from when an imaging instruction is given to when exposure is completed, and a preview image is displayed as soon as imaging is completed. In other words, the screen goes black once after an imaging instruction is given, and imaging is completed when the next image is displayed on the screen.

On the other hand, the image stabilization using image combination captures a plurality of images and thus can display a first captured image while a second image is being captured, and the second captured image while the third image is being captured. This enables the user to perform imaging while viewing images in (almost) real time during imaging even though FPS is low, and to suppress camera shake caused during imaging. In other words, the screen display after an imaging instruction is given is different from that of long-exposure imaging, and the screen goes black once after the imaging instruction is given, and imaging continues when an image is displayed next time.

Many image pickup apparatuses can automatically set imaging settings so that users who are not familiar with the imaging settings can capture images under proper imaging conditions. In a case where the image pickup apparatus automatically determines whether the image stabilization using image combination function is enabled regardless of the user's settings, the user may misunderstand (or mistake) an imaging end.

### SUMMARY

A control apparatus according to one aspect of the disclosure includes a processor configured to perform first processing for continuously shooting a plurality of images with a single imaging instruction, aligning the plurality of images, and combining the plurality of images into a single image. An output of an output unit during imaging executing the first processing in a first mode for automatically determining whether or not to execute the first processing is different from that during imaging executing the first processing in a second mode. An image pickup apparatus having the above control apparatus also constitutes another aspect of the disclosure. A control method corresponding the above control apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B explain an image pickup apparatus according to each embodiment.

FIG. 2 illustrates the display during long-exposure imaging in each embodiment.

FIG. 3 illustrates the display during imaging with image stabilization using image combination in each embodiment.

FIG. 4 illustrates the screen display during imaging with image stabilization using image combination in an automatic mode in a first embodiment.

FIG. 5 illustrates the screen display during long-exposure imaging in an automatic mode in a second embodiment.

FIG. 6 illustrates the screen display during imaging with image stabilization using image combination in an automatic mode in a third embodiment.

FIGS. 7A and 7B illustrate the screen display during imaging with image stabilization using image combination in the automatic mode in the third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### Configuration of the Imaging System

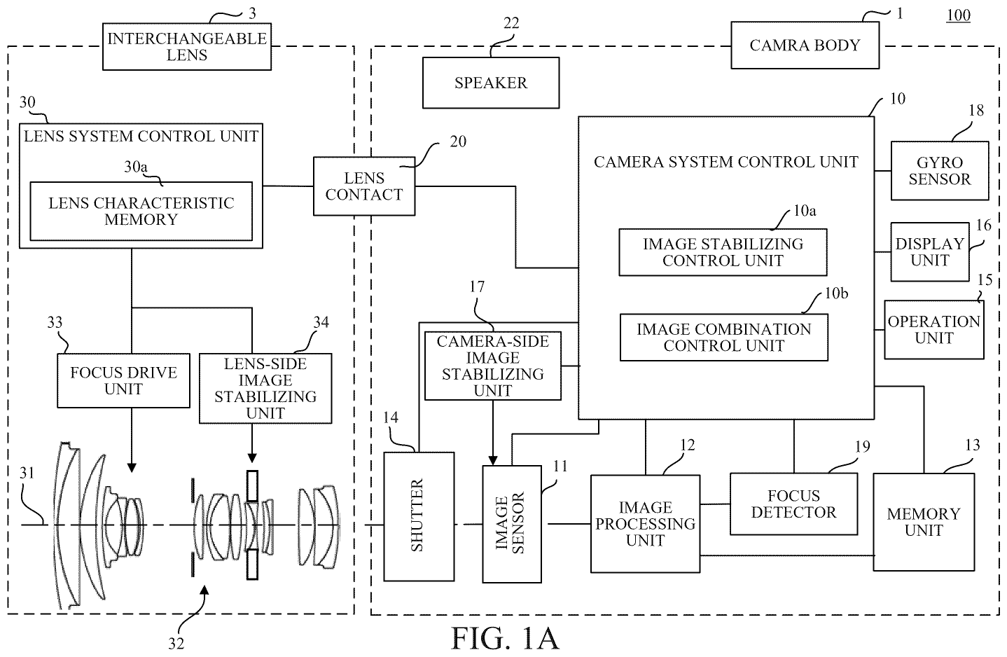

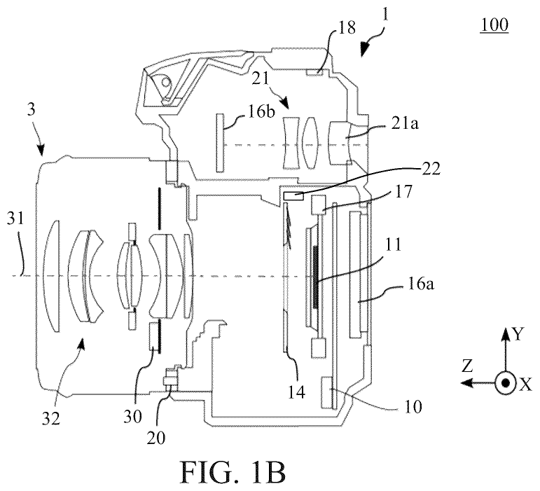

Referring now to FIGS. 1A and 1B, a description will be given of an imaging system 100 according to each embodiment. FIG. 1A is a block diagram of the imaging system 100. FIG. 1B is a sectional view of the imaging system 100. The imaging system 100 includes a camera body (image pickup apparatus) 1 and an interchangeable lens (lens apparatus) 3 that is attachable to and detachable from the camera body 1. However, this embodiment is not limited to this configuration, and can also be applied to an image pickup apparatus in which the camera body and the lens apparatus are integrated.

The camera body 1 includes an image sensor 11, an image processing unit 12, a memory unit 13, a shutter (focal plane shutter) 14, an operation unit 15, a display unit (output unit) 16, and a viewfinder optical system 21. The image sensor 11 is a photoelectric conversion element such as a CMOS sensor or a CCD sensor, and photoelectrically converts an optical image (object image) formed by an imaging optical system 32 in the interchangeable lens 3. The image processing unit 12 generates an image (image information) from the information photoelectrically converted by the image sensor 11. The memory unit 13 stores information such as image information. The shutter 14 controls the blocking or passage of light to the image sensor 11. The operation unit 15 recognizes user operations. The display unit 16 displays images and the like.

As illustrated in FIG. 1B, the display unit 16 includes a rear LCD unit 16a disposed on the rear (right side) of the camera body 1, and a viewfinder display unit 16b viewable through an eyepiece lens 21a of the viewfinder optical system 21. The display unit 16 displays images such as live-view images and preview images, as described below. In a case where a camera system control unit 10 has an image stabilization using image combination function, the display unit 16 can sequentially display a plurality of images during imaging. The user can arbitrarily switch between displaying an image on the rear LCD unit 16a and displaying an image on the viewfinder display unit 16b.

The camera body 1 includes a camera-side image stabilizing unit 17, a gyro sensor 18, and a camera system control unit 10. The camera-side image stabilizing unit 17 moves (shifts) the image sensor 11 in a direction approximately orthogonal to the optical axis 31 (direction orthogonal to the optical axis). The gyro sensor 18 is a shake detector (rotational shake detector) that detects the angular velocity of the rotational shake of the camera body 1. The camera system control unit 10 is a control unit that controls each component of the camera body 1. The camera system control unit 10 includes an image stabilizing control unit 10a that performs image stabilizing control, and an image combination control unit 10b that performs image combination control.

The interchangeable lens 3 includes an imaging optical system 32, a focus driving unit 33, a lens-side image stabilizing unit 34, and a lens system control unit 30. The imaging optical system 32 includes a plurality of lenses arranged along an optical axis 31 and allows light rays to pass through. The focus driving unit 33 drives the focus lens in the optical axis direction. The lens-side image stabilizing unit 34 shifts the shift lens (image stabilizing lens) in a direction orthogonal to the optical axis and rotates it around an axis approximately parallel to the optical axis 31. The lens system control unit 30 controls each component in the interchangeable lens 3. The lens system control unit 30 includes a lens characteristic memory 30a that stores a lens drive characteristic.

The camera body 1 and the interchangeable lens 3 can communicate electrical signals via a lens contact 20 that is electrically connected. The shutter 14 includes a shutter curtain including a front curtain and a rear curtain, and controls the blocking and passing of light rays from the imaging optical system 32 to the image sensor 11 by moving each shutter curtain within a shutter opening. The driving of the shutter 14 is controlled by the camera system control unit 10.

The light rays that pass through the imaging optical system 32 of the interchangeable lens 3 and the opening of the shutter 14 and are received by the image sensor 11 are photoelectrically converted, and an unillustrated A/D converter performs quantization processing for a photoelectrically converted output. The image processing unit 12 includes a white balance circuit, a gamma correction circuit, an interpolation calculation circuit, etc. and generates image data from a signal acquired from the image sensor 11 upon receiving a command from the camera system control unit 10. The image data generated by the image processing unit 12 is stored in the memory unit 13.

The camera system control unit 10 has a CPU and the like, and generally controls the camera body 1 including communication with the interchangeable lens 3. The camera system control unit 10 generates a timing signal during imaging and outputs it to each component. In a case where a release button included in the operation unit 15 is pressed and an operation instruction is accepted, the camera system control unit 10 controls the image sensor 11 according to the operation instruction and transmits a command signal to the lens system control unit 30. The release button can detect a so-called half-press operation which is a first stage of press amount, and a so-called fully press operation, which is a second stage of press amount from the half-press operation. In a case where a half-press operation is detected, a command is issued for an imaging preparatory operation, such as an autofocus (AF) operation. In a case where a fully pressed operation of the release button is detected from the half pressed state, the shutter 14 is driven to start an exposure operation for still image imaging. According to the setting, a plurality of continuous exposure operations for still image imaging can be performed by pressing the release button once.

The camera body 1 further includes a built-in speaker (sound playback unit, output unit) 22. The speaker 22 plays back a sound such as an operation sound of the setting and a shutter sound during imaging, as necessary.

### Image Stabilization Operation

A description will now be given of image stabilization. First, the camera-side image stabilizing unit 17 will be described. The gyro sensor 18 is an angular shake sensor that detects an angular velocity (angular velocity signal) caused by the rotation of the camera body 1. The camera system control unit 10 performs filtering processing and integration processing for the angular velocity signal from the gyro sensor 18 to calculate the angular shake component of the camera body 1 and generate a drive signal for the camera-side image stabilizing unit 17.

As illustrated in FIG. 1B, a direction toward the interchangeable lens 3 among the directions along the optical axis 31 is a positive direction of the Z-axis, an upward direction of the camera body 1 is a positive direction of the Y-axis, and a direction toward the front side of an axis orthogonal to each of the Z-axis and Y-axis is a positive direction of the X-axis. At this time, the gyro sensor 18 can calculate the angular velocity caused by the rotation about each axis of the camera body 1. The gyro sensor 18 can be configured as one package, or may include three identical packages in directions of the angular axes.

The camera-side image stabilizing unit 17 performs image stabilization by shifting image sensor 11 in the XY plane that is approximately orthogonal to optical axis 31 and rotating it around an axis approximately parallel to the Z-axis (optical axis 31) using a signal based on the detection result (angular velocity signal) of the gyro sensor 18. The camera-side image stabilizing unit 17 corrects rotational shake in the pitch and yaw directions of camera body 1 by shifting image sensor 11 in the XY plane. The camera-side image stabilizing unit 17 also corrects roll shake by rotating the image sensor 11 around an axis approximately parallel to the Z-axis, which is the optical axis 31.

Similarly, the lens-side image stabilizing unit 34 receives a drive signal generated by camera system control unit 10 via the lens contact 20 and lens system control unit 30 and drives the shift lens. Unlike the camera-side image stabilizing unit 17, the lens-side image stabilizing unit 34 corrects only the rotational shake in the pitch and yaw directions of the camera body 1 by only shifting the image sensor 11 in the XY plane that is approximately orthogonal to the optical axis 31.

### Image Stabilization Using Image Combination

A description will now be given of image stabilization using image combination. In capturing a proper photo (image) in an environment with an insufficient light amount, it is generally known to perform processing (second processing) of increasing the exposure time (capturing an image with an exposure time longer than a predetermined time) (long-exposure imaging). However, as the exposure time becomes longer, the camera shake influence increases, even the above image stabilizing operation may not be able to correct it completely, and an image may be significantly blurred. Accordingly, there is proposed a function for aligning and combining a plurality of images output from the image sensor 11 in chronological order using the image processing unit 12 (image stabilization using image combination). In other words, the camera system control unit 10 continuously shoots a plurality of images with a single imaging instruction, and performs processing for combining the plurality of images into a single image while aligning them.

The image processing unit 12 aligns the images by translational movement with two-pixel unit accuracy using the motion vectors among a plurality of images. The image combined by the image processing unit 12 is recorded in the memory unit 13.

In the image stabilization using image combination, images are divided so that the whole exposure time of the images is the same as the exposure time in long-exposure imaging. For example, in the case of long-exposure imaging with an exposure time of 1 second, an image with exposure equivalent to that of long-exposure imaging and reduced blur can be obtained by aligning and combining 10 continuously shot images with an exposure time of 1/10 seconds.

However, in performing image stabilization using image combination, it is arduous for the user to set the exposure time per image, how many images to shoot, and the like, so the camera system control unit 10 can automatically determine suitable settings and perform imaging. The camera system control unit 10 also has a plurality of modes including a first mode and a second mode. The first mode is a mode (automatic mode) in which the camera system control unit 10 automatically (without being instructed by the user) determines whether or not to perform processing (first processing) for imaging with image stabilization using image combination. The second mode is a mode (manual mode) in which processing (second processing) for imaging with image stabilization using image combination is performed, for example, at the user's instruction.

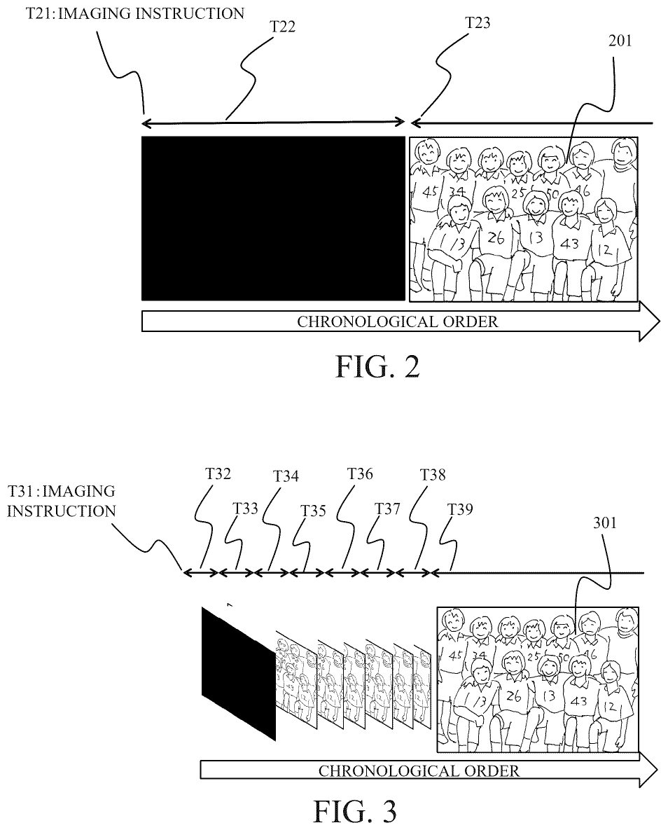

Referring now to FIG. 2, a description will be given of a display method after an imaging instruction is given during imaging with the image stabilization using image combination function and that during long-exposure imaging. FIG. 2 illustrates the display method of the display unit 16 during long-exposure imaging. FIG. 2 illustrates the display of the display unit 16 in chronological order along a direction from left to right from when an imaging instruction is given to when imaging is completed and a preview screen after imaging is displayed on the display unit 16 in long-exposure imaging.

When the user gives an imaging instruction at timing T21, exposure begins, and nothing is displayed on the display unit 16 during the exposure period (section T22). When imaging is completed at timing T23, a preview image 201 of a captured image is displayed on the display unit 16. In other words, the user is to hold the camera body 1 still while viewing the display unit 16, which displays nothing during the exposure period (section T22). This has little impact in a case where the exposure time is short, but in the long-exposure imaging, it is difficult to hold the camera body 1 while no live-view image is displayed, and camera shake may increase.

Referring now to FIG. 3, a description will be given of the display during imaging with the image stabilization using image combination. FIG. 3 illustrates the display on the display unit 16 during imaging with the image stabilization using image combination function.

As an example, a description will be given of the display method (behavior) in combining six images. In imaging with image stabilization using image combination, as described above, continuous shooting is performed with a short exposure time to combine images with reduced blur. In this case, while the second image of the continuous shooting is being exposed, the first image that has been previously captured can be displayed on the display unit 16. That is, after the user issues an imaging instruction at timing T31, the first image is exposed during the first exposure period (section T32). During the first exposure period (section T32), nothing is displayed on the display unit 16.

After imaging of the first image is completed, exposure of the second image begins during the second exposure period (section T33). During the second exposure period (section T33), a preview image of the first captured image is displayed on the display unit 16. Similarly, exposure of the third image begins during the third exposure period (section T34), and a preview of the second image is displayed on the display unit 16. Similar processing is performed in the fourth exposure period (section T35), the fifth exposure period (section T36), and the sixth exposure period (section T37). During the seventh exposure period (section T38), no exposure is performed, and these six captured images are aligned and combined during this period. During the seventh exposure period (section T38), a preview image of the sixth image is displayed on the display unit 16.

At timing T39 when the image stabilization using image combination is completed, a preview image 301 of the combined image is displayed on the display unit 16. Thereby, in imaging with image stabilization using image combination, a plurality of images that are being shot can be displayed in approximately real time, and an increase in camera shake can be suppressed.

A description will now be given of the problems in the automatic mode. In the automatic mode, the camera body 1 automatically determines whether to perform imaging with the image stabilization using image combination function, or to perform long-exposure imaging without the image stabilization using image combination function. In other words, in the case of an imaging condition near a threshold that is used to determining whether to use the image stabilization using image combination function, imaging with image stabilization using image combination and long-exposure imaging are mixed. In this case, the user may misunderstand the imaging end. This will be described in detail below.

In the case of long-exposure imaging, the display on the display unit 16 goes black once after the imaging instruction is given, and when the display on the display unit 16 appears next, a preview image is displayed after imaging is completed. On the other hand, in imaging with the image stabilization using image combination function, the display on the display unit 16 goes black once after the imaging instruction is given, and imaging is still continuing when the display on the display unit 16 appears next and a real-time image is displayed. In other words, a display method of the display unit 16 during the long-exposure imaging where the display on the display unit 16 goes black after the imaging instruction is given and an image is next displayed on the display unit 16 is different from that during imaging with the image stabilization using image combination function.

If a user performs imaging by considering it to be long-exposure imaging, when the display on the display unit 16 turns off once after the imaging instruction is given and then appears on the display unit 16, the user determines that imaging is completed and often stops holding the camera body 1 still. If the camera body 1 determines that the imaging was performed with the image stabilization using image combination function, imaging is still in progress when an image is displayed again on the display unit 16. Thus, since the user stops holding the camera body 1 still, an image has a large blur amount. In each embodiment, a preview image of a captured image is displayed on the display unit 16 after imaging is completed. However, according to the setting of the camera body 1, a live-view image may be displayed without displaying the preview image.

Accordingly, in each embodiment, an image display method during imaging with the image stabilization using image combination function (first processing) or an image display method during long-exposure imaging (second processing) in the automatic mode is different from that in another mode so as to prevent the user from misunderstanding the imaging end timing. Each embodiment will be described in detail below.

### First Embodiment

A description will now be given of a first embodiment according to the present disclosure. During imaging with image stabilization using image combination, unlike long-exposure imaging, an image can be displayed in real time during the exposure period. Thereby, the user can easily hold the camera body 1 during the exposure period, and one factor of camera shake can be suppressed. Nevertheless, in the automatic mode in which the camera body 1 automatically determines whether the image stabilization using image combination function is enabled or disabled, the user may misunderstand the imaging timing due to the display method difference from that during long-exposure imaging. Accordingly, in this embodiment, in a case where the camera body 1 is set to the automatic mode, a real-time image is not displayed on the display unit 16 during image stabilization using image combination (in a case where it is determined that the image stabilization using image combination function is enabled).

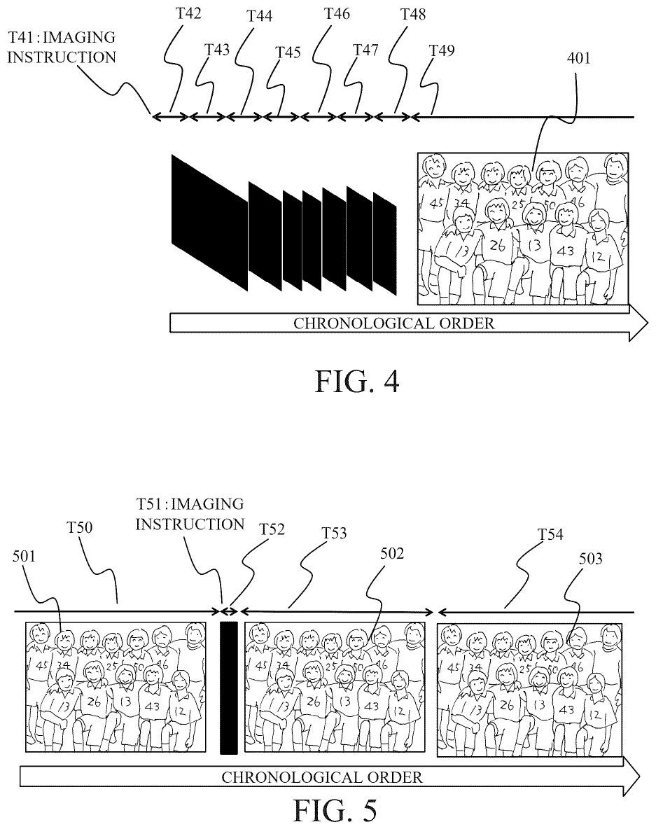

Referring now to FIG. 4, a description of a concrete example will be given. FIG. 4 illustrates the screen display during imaging with image stabilization using image combination in the automatic mode, in chronological order from left to right in FIG. 4.

After an imaging instruction is given at timing T41, normally (for example, in a manual mode), the display on the display unit 16 goes black once in section T42, and a real-time image is displayed on the display unit 16 from section T43 to section T48. On the other hand, in an automatic mode, no real-time image is displayed on the display unit 16, and no image is displayed on the display unit 16 until a combined image 401 is previewed at timing T49. In other words, the display method (screen display method) is changed so that it can be the same as that during long-exposure imaging.

Thus, in this embodiment, during imaging in the automatic mode, the display method is controlled so that the display on the display unit 16 during imaging with the image stabilization using image combination function and the display on the display unit 16 during long-exposure imaging are similar. Thereby, in this embodiment, the user is less likely to misunderstand the imaging end timing.

### Second Embodiment

Next, a second embodiment of the present disclosure will be described. In this embodiment, during long-exposure imaging in an automatic mode (in a case where it is determined that the image stabilization using image combination function is disabled), an image just before the imaging instruction is given is displayed during the exposure period. In other words, after the imaging instruction is given, an image displayed on the display unit 16 goes black once, and even if an image is next displayed on the display unit 16, imaging is still continuing, so this is equivalent to the display method (behavior) during imaging with the image stabilization using image combination.

Referring now to FIG. 5, a description of a concrete example will be given. FIG. 5 illustrates the screen display during long-exposure imaging in the automatic mode, in chronological order from left to right.

When an imaging instruction is given by the user at timing T51, a live-view image 501 is displayed on the display unit 16 in a section T50 just before the timing T51. After the imaging instruction is given, the image displayed on the display unit 16 goes black once in section T52. Then, in section T53, a live-view image 502 just before the imaging instruction timing T51 is displayed on the display unit 16. In section T54 after the exposure is completed, a preview image 503 of the captured image is displayed on the display unit 16. In this case, the total time of the sections T52 and T53 is equal to the exposure period. The start of the section T52 may be earlier than the start of the exposure period, and the end of the section T53 may be later than the end of the exposure period. In the section T53, an image indicating that the exposure period is in progress may be displayed in addition to the live-view image 502.

In this embodiment, the display method during long-exposure imaging (in a case where imaging with the image stabilization using image combination function is determined to be disabled) in the automatic mode is different from the display method of the display unit 16 during long-exposure imaging in a non-automatic mode (such as a manual mode). This configuration can reduce a difference between a display method during long-exposure imaging and a display method during imaging with the image stabilization using image combination function. As a result, in this embodiment, the user is less likely to misunderstand the imaging end timing.

### Third Embodiment

Next, a third embodiment of the present disclosure will be described. As described above, during imaging with the image stabilization using image combination function, unlike long-exposure imaging, an image can be displayed in real time during the exposure period. Thereby, the user can easily hold the camera body 1 during the exposure period, and one factor of camera shake can be suppressed. Nevertheless, in the automatic mode in which the camera body 1 automatically determines whether the image stabilization using image combination function is enabled or disabled, the user may misunderstand the imaging timing due to a difference from the display method during long-exposure imaging. Accordingly, in this embodiment, in the automatic mode, a real-time image is reduced and displayed on the display unit 16 during imaging with the image stabilization using image combination. For example, the display size of the image displayed on the display unit 16 is reduced to about half (½) as large as the area of the display unit 16.

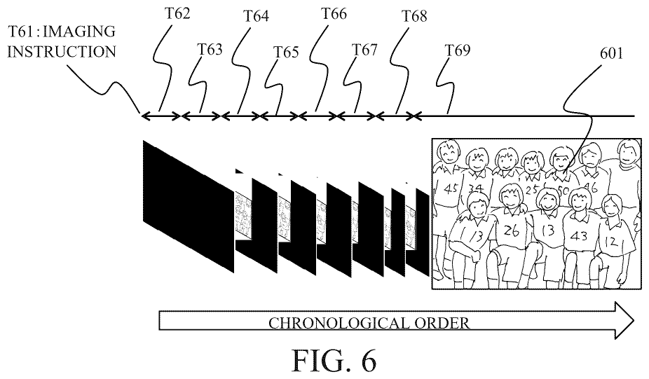

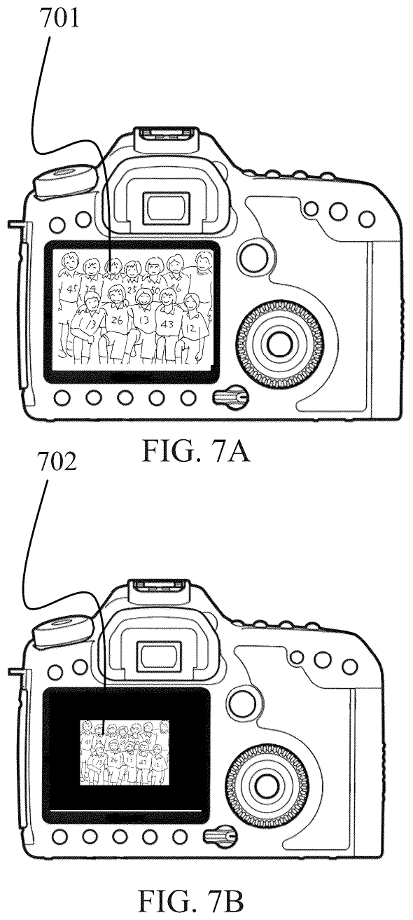

Referring now to FIGS. 6, 7A, and 7B, a concrete example will be given. FIG. 6 illustrates the screen display during imaging with image stabilization using image combination in the automatic mode, in chronological order from left to right in FIG. 6.

After an imaging instruction is given at timing T61, continuous shooting is performed sequentially from section T62 to section T68, and a plurality of captured images are displayed as real-time images on the display unit 16 from section T63 to section T69. In this embodiment, the image size at that time is reduced to about ½, for example, and the images are displayed. An image 601 displayed in section T69 has the original image size, but may be displayed in a reduced size, similarly to the images displayed in sections T63 to T68.

FIGS. 7A and 7B illustrate an example where a plurality of images are displayed on the rear LCD unit 16a in sections T63 to T69. Normally (in a mode such as a manual mode other than an automatic mode), as illustrated in FIG. 7A, an image (real-time image) 701 is displayed at a size substantially equal to the area of the rear LCD unit 16a. However, in this embodiment, as illustrated in FIG. 7B, an image 702 is displayed and reduced to about half the area of the rear LCD unit 16a.

In this embodiment, the real-time image is displayed in a reduced size, so that the image displayed on the display unit 16 goes black once after an imaging instruction is issued, and the next displayed image (image size) has a size different from that of the normal display. Thus, the user can clearly confirm whether or not imaging with the image stabilization using image combination function is being performed. Thereby, according to this embodiment, during imaging in automatic mode, a real-time image can be displayed during imaging with the image stabilization using image combination function and the user is less likely to misunderstand the imaging end timing. A method different from the normal display includes, in addition to displaying a real-time image in a reduced size, displaying an image that is made by partially cutting a real-time image, displaying a part of the real-time image by masking it, and superimposing another image on a part of the real-time image.

### Fourth Embodiment

Next, a fourth embodiment of the present disclosure will be described. In this embodiment, a sound played back from the speaker 22 during imaging with the image stabilization using image combination function in the automatic mode is different from a sound played back in another case (such as the case of long-exposure imaging). The user can determine whether it is imaging withj the image stabilization using image combination function or long-exposure imaging based on a difference in the sound played back after an imaging instruction is given. Thus, in this embodiment, the user is less likely to misunderstand the imaging end timing.

In this embodiment, the display method may be changed as described in the first to third embodiments along with the sound during imaging, or the display method may not be changed by changing the sound.

According to each embodiment, during imaging in the automatic mode, the user is likely to misunderstand the imaging end timing due to a difference between the display method during imaging with image stabilization using image combination and the display method during long-exposure imaging. Thus, each embodiment can provide a control apparatus, an image pickup apparatus, a control method, and a storage medium, in which the user is less likely to misunderstand the imaging end timing in a case where the image pickup apparatus automatically determines whether to execute an image stabilization using image combination function.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-001629, which was filed on Jan. 10, 2024, and which is hereby incorporated by reference herein in its entirety.

What is claimed is:

1. A control apparatus comprising:
a processor configured to perform first processing for continuously shooting a plurality of images with a single imaging instruction, aligning the plurality of images, and combining the plurality of images into a single image,
wherein an output of an output unit during imaging executing the first processing in a first mode for automatically determining whether or not to execute the first processing is different from that during imaging executing the first processing in a second mode.

2. The control apparatus according to claim 1, wherein the output unit includes a display unit configured to sequentially display the plurality of images during imaging executing the first processing.

3. The control apparatus according to claim 2, wherein a display method of the display unit during imaging executing the first processing in the first mode is different from that during imaging executing the first processing in the second mode.

4. The control apparatus according to claim 2, wherein in a case where the first processing is determined to be executed in the first mode, the processor is configured not to sequentially display the plurality of images on the display unit during imaging.

5. The control apparatus according to claim 2, wherein in a case where the first processing is determined not to be executed in the first mode, the processor is configured to display on the display unit an image captured before the single imaging instruction.

6. The control apparatus according to claim 2, wherein in a case where the first processing is determined to be executed in the first mode, the processor is configured to display the plurality of images on the display unit in changed display sizes.

7. The control apparatus according to claim 2, wherein the processor is configured to perform second processing for performing imaging with an exposure time longer than a predetermined time, and
wherein a display method of the display unit during imaging executing one of the first processing and the second processing in the first mode is different from that during imaging executing the one in the second mode.

8. The control apparatus according to claim 1, wherein the output unit includes a sound playback unit configured to play back a sound.

9. The control apparatus according to claim 8, wherein the sound played back by the sound playback unit during imaging executing the first processing in the first mode is different from that during imaging executing the first processing in the second mode.

10. The control apparatus according to claim 8, wherein the processor is configured to change the sound played back by the sound playback unit during imaging executing the first processing in the first mode.

11. The control apparatus according to claim 1, wherein the second mode is a mode in which the first processing is executed according to an instruction by a user.

12. An image pickup apparatus comprising:
an image sensor;
a processor configured to perform first processing for continuously shooting a plurality of images using the image sensor with a single imaging instruction, aligning the plurality of images, and combining the plurality of images into a single image; and
an output unit,
wherein an output of the output unit during imaging executing the first processing in a first mode for automatically determining whether or not to execute the first processing is different from that during imaging executing the first processing in a second mode.

13. A control method comprising:
performing first processing for continuously shooting a plurality of images with a single imaging instruction, aligning the plurality of images, and combining the plurality of images into a single image,
wherein an output of the output unit during imaging executing the first processing in a first mode for automatically determining whether or not to execute the first processing is different from that during imaging executing the first processing in a second mode.
